(19) United States
(12) Patent Application Publication
(10) Pub. No.: US 2013/0247448 A1
(43) Pub. Date: Sep. 26, 2013

(54) OPTIMIZATION OF TORREFACTION VOLATILES FOR PRODUCING LIQUID FUEL FROM BIOMASS

(71) Applicants: Robert S. Ampulski, Fairfield, OH (US); Timothy E. Laska, Loveland, OH (US); John T. Turner, West Chester, OH (US); Sidney P. White, Fort Collins, CO (US)

(72) Inventors: Robert S. Ampulski, Fairfield, OH (US); Timothy E. Laska, Loveland, OH (US); John T. Turner, West Chester, OH (US); Sidney P. White, Fort Collins, CO (US)

(73) Assignee: SUNDROP FUELS, INC., Longmont, CO (US)

(21) Appl. No.: 13/429,759

(22) Filed: Mar. 26, 2012

(51) Int. Cl. C10L 1/00; B01J 8/00

(52) U.S. Cl. 44/307; 422/187; 422/119; 422/105

(57) ABSTRACT

Generation of a liquid fuel product in an integrated multiple zone plant is discussed. Syngas components are supplied to a methanol (CH3OH) synthesis reactor from outputs of a first zone containing a torrefaction unit and a second zone containing a biomass gasifier that are combined in parallel and that thermally decompose biomass at different operating temperatures. Char particles of the biomass generated in the first zone are fed to the biomass gasifier in the second zone. Gasoline is produced via a methanol to gasoline process in a third zone, which receives its methanol derived from the syngas components fed to the methanol synthesis reactor. The gasoline derived from biomass is blended with condensable volatile materials including C5+ hydrocarbons collected during the pyrolyzation of the biomass in the torrefaction unit in the first zone in order to increase an octane rating of the blended gasoline.

### FIELD

The invention generally relates to an optimization of torrefaction volatiles for producing liquid fuel from biomass and in an embodiment specifically to a multiple zone integrated plant to produce liquid fuels from the biomass.

### BACKGROUND

Prior to the emergence of the petrochemical industry, wood distillation was the primary source of industrially important organic chemicals, but most wood distillation plants were closed by 1950. A resurgence in interest in wood distillation products arose in the late 1900's, as efforts were focused on renewable energy sources as an alternative to petroleum (Gade 2010). Much of this renewed interest has been in the use of fast pyrolysis to produce bio-oil, or “bio-crude.” In this process, biomass of small particle size is rapidly heated (1-2 sec), at high temperature (500° C.), and the vapor is rapidly cooled, to yield ˜70% liquid bio-oil. The bio-oil is an acidic, highly oxygenated, product that is subject to aging and must be further refined to produce satisfactory liquid fuels. To date, no large-scale commercialization of bio-oil or other integrated plant to economically make bio-fuel has been achieved.

### SUMMARY

In an embodiment, a multiple zone integrated plant to generate a liquid fuel product may include three or more zones. A first and second zone are fed in series and have a portion of their outputs that are combined in parallel to feed syngas components, including hydrogen (H2) and carbon monoxide (CO), in a proper ratio to a methanol (CH₃OH) synthesis reactor. The first zone includes a torrefaction unit to pyrolyze biomass at a temperature of less than 700 degrees C. for a preset amount of time to create off gases to be used in a creation of a portion of the syngas components fed to the methanol synthesis reactor. The second zone includes a biomass gasifier to react char particles of the biomass from the first zone in the presence of steam in a rapid biomass gasification reaction at a temperature of greater than 1000 degrees C. in less than a five second residence time in the biomass gasifier to create another portion of the syngas components fed to the methanol synthesis reactor. The third zone includes a gasoline blending, unit that is configured to blend gasoline produced from a methanol to gasoline (MTG) reactor, which receives its methanol derived from the syngas components in the proper ratio fed to the methanol synthesis reactor. The gasoline blending unit is configured to blend the gasoline from the methanol to gasoline reactor with condensable volatile materials, including C5+ hydrocarbons collected during the pyrolyzation of the biomass in the torrefaction unit in the first zone. Thus, the gasoline derived from the syngas components from the biomass produced in the first two zones is blended with non-condensable materials from the first zone. In sum, the torrefaction unit is configured to produce and collect 1) condensable materials with significant fuel blending value, 2) char, and 3) non-condensable gases including C1-4 olefins. The torrefaction unit is configured to route the separated products as follows 1) condensable materials with significant fuel blending value are routed to the gasoline blending unit, 2) char is routed as a feedstock for the biomass gasifier, which produces a portion of the syngas components, and 3) non-condensable gases including C1-4 olefins are routed to a catalytic reactor in parallel with biomass gasifier in order to create the other portion of the syngas component to be fed to the methanol synthesis reactor.

### BRIEF DESCRIPTION OF THE DRAWINGS

The multiple drawings refer to the example embodiments of the invention.

FIG. 1 illustrates a flow schematic of an embodiment of a multiple zone integrated plant to generate a liquid fuel product that may include three or more zones.

FIG. 2 illustrates a flow schematic of an embodiment of a torrefaction unit feeding a particle size reduction unit and the alternative syngas and fuel blending pathways.

FIG. 3 illustrates a flow schematic of an embodiment of the syngas to methanol to gasoline process.

FIG. 4 illustrates a flow schematic of an embodiment of the multiple zone integrated plant.

FIG. 5A illustrates a flow schematic of an embodiment for the radiant heat chemical reactor configured to generate chemical products including synthesis gas products.

FIG. 5B illustrates a table of volatiles produced in an example torrefaction unit that is segregated into two or more stages.

FIG. 6 illustrates a block diagram of embodiments for an entrained-flow biomass feed system that supplies the biomass particles and heat-transfer-aid particles in a carrier gas to the chemical reactor.

FIG. 7 illustrates a diagram of an embodiment of the integrated multiple zone bio-refinery with multiple control systems that interact with each other.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific chemicals, named components, connections, types of heat sources, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

In general, a number of example processes for and apparatuses associated with a multiple zone integrated chemical plant are described. The following drawings and text describe various example implementations for methods and apparatus to generate a liquid fuel product in an integrated multiple zone plant. Syngas components are supplied to a methanol (CH3OH) synthesis reactor from outputs of a first zone containing a torrefaction unit and a second zone containing a biomass gasifier that are combined in parallel and that thermally decompose biomass at different operating temperatures. Char particles of the biomass generated in the first zone are fed to the biomass gasifier in the second zone. Gasoline is produced via a methanol to gasoline process in a third zone, which receives its methanol derived from the syngas components fed to the methanol synthesis reactor. The gasoline derived from biomass is blended with condensable volatile materials including C5+ hydrocarbons collected during the pyrolyzation of the biomass in the torrefaction unit in the first zone in order to increase an octane rating of the blended gasoline. One skilled in the art will understand parts and aspects of many of the designs discussed below within this illustrative document may be used as stand-alone concepts or in combination with each other.

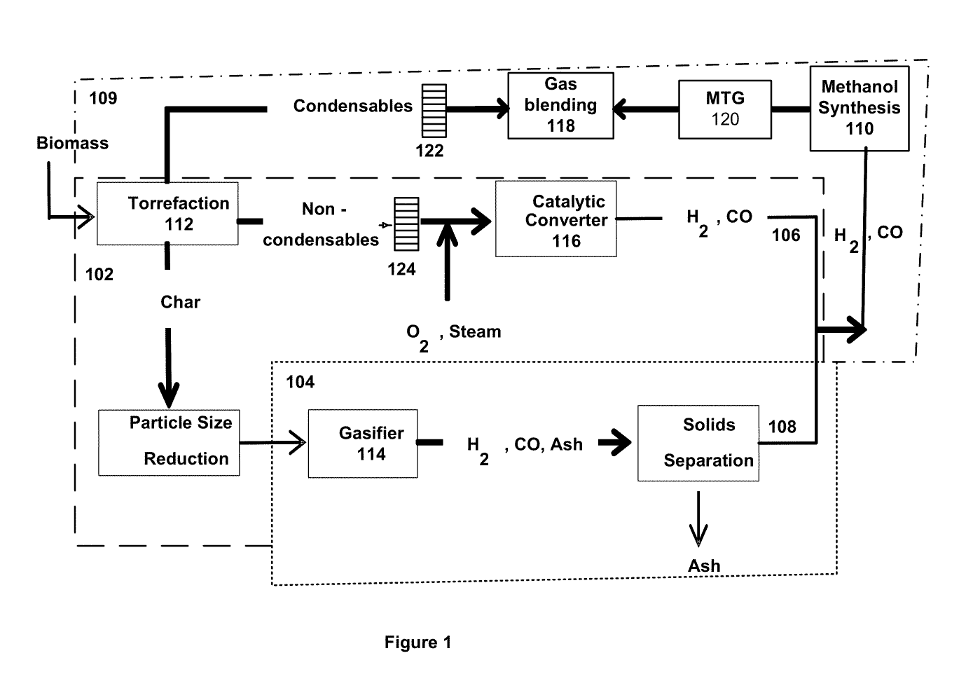

FIG. 1 illustrates a flow schematic of an embodiment of a multiple zone integrated plant to generate a liquid fuel product that may include three or more zones. A first zone 102 and a second zone 104 are fed in series and have a portion of their outputs 106, 108 that are combined in parallel to feed syngas components, including hydrogen (H2) and carbon monoxide (CO), in a proper ratio to a methanol (CH3OH) synthesis reactor 110. The first zone 102 includes a torrefaction unit 112 to pyrolyze biomass at a temperature of less than 700 degrees C. for a preset amount of time to create off gases to be used in a creation of a portion of the syngas components fed to the methanol synthesis reactor. The second zone 104 includes a biomass gasifier 114 to react char particles of the biomass from the first zone 102 in the presence of steam in a rapid biomass gasification reaction at a temperature of greater than 1000 degrees C. in less than a five second residence time in the biomass gasifier 114 to create another portion of the syngas components fed to the methanol synthesis reactor 110. Syngas may be a mixture of carbon monoxide and hydrogen produced by torrefaction and catalyst as well as gasification of the biomass and can be converted into a large number of organic compounds that are useful as chemical feed stocks, fuels and solvents.

The torrefaction unit 112 in the first zone 102 is configured to produce and collect 1) condensable materials with significant fuel blending value, 2) char, and 3) non-condensable gases including C1-4 olefins. The torrefaction unit 112 is configured to route the separated products as follows 1) condensable materials with significant fuel blending value are routed to the gasoline blending unit 118, 2) char is routed as a feedstock for the biomass gasifier 114, which produces a portion of the syngas components, and 3) non-condensable gases including C1-4 olefins are routed to a catalytic reactor in parallel with biomass gasifier 114 in order to create the other portion of the syngas component to be fed to the methanol synthesis reactor 110.

Torrefaction may be a thermo chemical process used to pretreat biomass to increase the efficiency of combustion and gasification processes. In this process, biomass is subjected to temperatures of 200-700° C. for ten to sixty minutes to drive off volatile materials, leaving a highly friable solid char material with increased energy density. During the low temperature stages of this thermal decomposition of the biomass, the biomass decomposes into volatile gases and solid char. Biomass is generally made up of a significantly higher amount of volatile matter than coal. For instance, up to 80 percent of the biomass can be volatile matter compared to coal, which is up to 20%.

Note, olefins may be any unsaturated hydrocarbon, such as ethylene, propylene, and butylenes, containing one or more pairs of carbon atoms linked by a double bond. Olefins may have the general formula CnH2n, C being a carbon atom, H a hydrogen atom, and n an integer. The olefins are formed during the thermal decomposition (breaking down of large molecules) of the biomass and are useful in the generation of a liquid fuel such as gasoline. Non-condensable olefins containing two to four carbon atoms per molecule (C2-C4) are generally gaseous at ordinary temperatures and pressure; whereas, condensable olefins generally contain five or more carbon atoms (C5+) and are usually liquid at ordinary temperatures and pressure. Cn usually denotes how many carbon molecules are making up the hydrocarbon compound.

The torrefaction unit 112 has two or more areas to segregate out and then route the non-condensable gases including the C1 to C4 olefins, as well as other gases including CO, CH4, CO2 and H2, through a supply line to the catalytic converter 116 that catalytically transform portions of the non-condensable gases to the syngas components of CO, H2, CO2 in small amounts, and potentially CH4 that are sent in parallel with the portion of syngas components from the biomass gasifier 114 to a combined input to the methanol synthesis reactor 110. The catalytic converter 116 has a control system to regulate a supply of an oxygenated gas and steam along with the non-condensable gases to the catalytic converter 116, which produces at least H2, and CO as exit gases. The catalytic converter 116 uses the control system and the composition of a catalyst material inside the catalytic converter 116 to, rather than convert the supplied non-condensable gases completely into CO2 and H2O in the exit gas, the non-condensable gases, steam, and oxygenated gas are passed through the catalytic converter 116 in a proper ratio to achieve an equilibrium reaction that favors a production of carbon monoxide (CO) and hydrogen (H2) in the exit gas; and thus, reclaim the valuable Renewable Identification Number (RIN) credits associated with the non-condensable gases. RIN credits are a numeric code that is generated by the producer or importer of renewable fuel representing gallons of renewable fuel produced using a renewable energy crop, such as biomass. The primary negative of torrefaction in prior suggestions is the loss of carbon and the associated RIN credits in the volatile materials removed by torrefaction.

The one or more catalytic converters may use a catalytic conversion process that oxidizes the incoming olefins as follows: CnH2n+[3nO2+1O2]/2→xCO2+xCO+x+1 H2O. For example, when the control system rapidly alternates the air to C1 to C4 non-condensable gas input into the catalytic converter 116, then the reaction runs heavy or lean of stoichiometry. By doing this the carbon monoxide and oxygen present in the exhaust gas from the converter alternates with the air to C1-C4 non-condensable ratio. When the air to C1-C4 non-condensable ratio is richer than stoichiometry, the carbon monoxide content of the exhaust gas rises and the oxygen and carbon dioxide content falls. Catalyst materials inside the converter 116, such as platinum/palladium/Rhodium/ and Cerium, may be used to promote the equilibrium reaction that favors a production of carbon monoxide (CO) and hydrogen (H2) in the exit gas. The cerium may store and release oxygen during these reactions. In the catalytic converter 116, the chemical catalyst material is used but not consumed to augment the chemical reaction.

The third zone 109 of the integrated plant includes a gasoline blending unit 118 that is configured to blend gasoline produced from a methanol to gasoline (MTG) reactor 120, which receives its methanol derived from the syngas components in the proper ratio fed to the methanol synthesis reactor 110. The gasoline blending unit 118 is configured to blend the gasoline from the methanol to gasoline reactor 120 with condensable volatile materials including C5+ hydrocarbons collected during the pyrolyzation of the biomass in the torrefaction unit 112 in the first zone 102. Thus, the gasoline derived from the syngas components from the biomass produced in the first two zones 102, 104 is blended with the condensable materials including C5+ hydrocarbons from the first zone 102.

A fuel value exists in the non-condensable and condensable volatiles. A compositional analysis of the non-condensable and condensable volatiles of biomass, such as rice hulls, torrefaction tests indicates that it is beneficial to blend the condensable materials, either directly or after additional processing, into an almost finished gasoline product derived from synthesis gas from a biomass gasification of the biomass and thereby not lose the associated RIN credits. The integrated plant makes it feasible and valuable to optimize the volatile yield from torrefaction of the biomass and thus recover the associated RIN credits when blending the volatiles compounds separated from the char in the low temperature torrefaction of the biomass with the almost finished gasoline product. The gasoline can be traced back to being derived from a high temperature biomass gasification of the biomass and the low temperature torrefaction of the biomass. Note, one or both of the torrefaction condensable and non-condensable volatiles may be utilized in the gasoline product.

The system is designed to remove the C1-C4 materials from the volatile stream and then blend the remaining C5+ materials in the stream directly into gasoline. This is beneficial to the finished gasoline product to increase its octane rating as the condensable blendable materials are largely olefins and branched hydrocarbons (CnH2n+2), which typically have higher octane ratings. There are some heavier materials, C25+, which may need to be removed by the filters 122, depending on the actual quantities in commercial production and type of biomass material being utilized by the integrated plant. An example assessment specifically for the volatiles collected from rice hull torrefaction, the potential to utilize the condensable volatile products of torrefaction and gain the valuable RIN credits with woody biomass is an alternative approach as well. Gasoline may be a complex mixture of potentially hundreds of different hydrocarbons. Most of the hydrocarbons are saturated and contain 4 to 12 carbon atoms per molecule.

Torrefaction is used as an initial step to decompose the complex hydrocarbons of biomass into simpler gaseous molecules including oxygen, carbon monoxide, and carbon dioxide methane, ethane, ethylene, propylene acetylene, acetone, propane, 1-butene, 1,3-butadiene, and other hydrocarbons released from the char as volatile materials.

Biomass gasification is used to decompose the complex hydrocarbons of biomass into simpler gaseous molecules, primarily hydrogen, carbon monoxide, and carbon dioxide. Some char, mineral ash, and tars are also formed, along with methane, ethane, water, and other constituents. The mixture of raw product gases vary according to the types of biomass feedstock used and gasification processes used. The product gas must be cleaned of solids, tars, and other contaminants sufficient for the intended use.

A sulfur filter 124 and other filters between the torrefaction unit 112 and the catalytic converter 116 receive the non-condensable gases collected and routed from the torrefaction unit 112. The sulfur filter 124 and other filters are configured to remove contaminants from the stream of non-condensable gases that would inactivate or otherwise harm the catalyst material within the catalytic converter 116. This may include sulfur compounds (e.g. H2S, mercaptans), nitrogen compounds (e.g. NH3, HCN), halides (e.g. HCl), and heavy organic compounds that are known collectively as “tar”. Next, depending on the catalyst being used and the product being made, the ratio of hydrogen to carbon monoxide may need to be adjusted and the carbon dioxide byproduct may also need to be removed. A similar set of sulfur and tar filters 122 is between the torrefaction unit 112 and the gas blending unit.

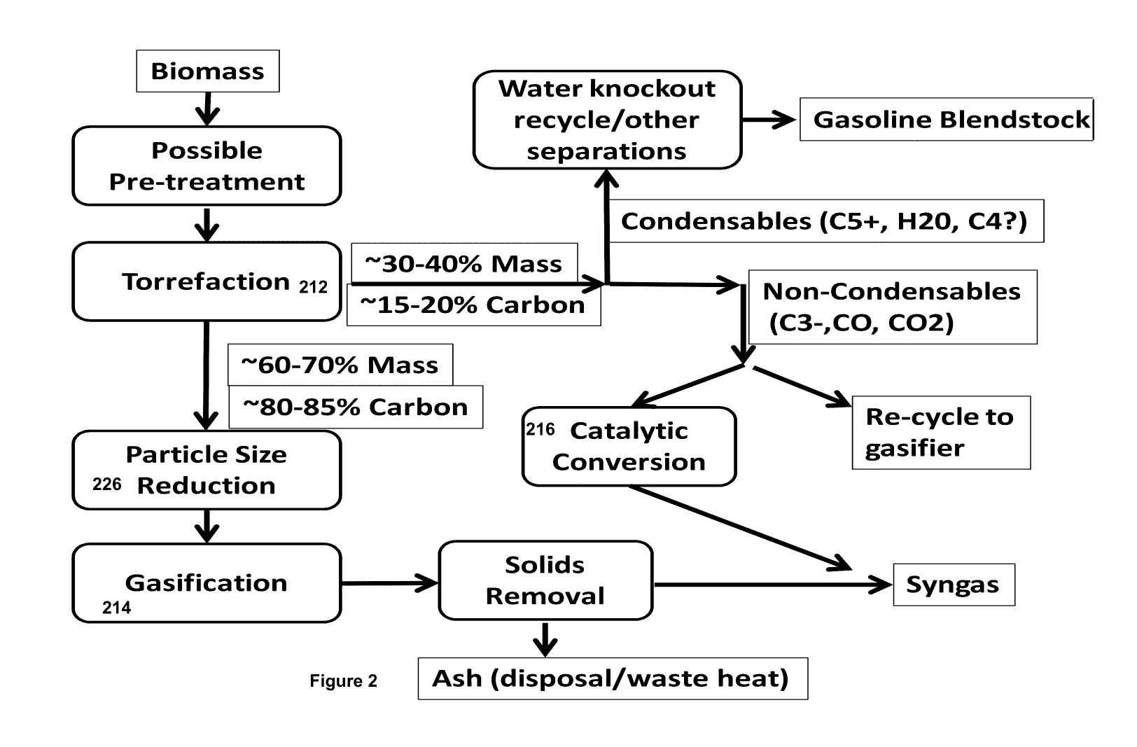

FIG. 2 illustrates a flow schematic of an embodiment of a torrefaction unit feeding a particle size reduction unit and the alternative syngas and fuel blending pathways.

Pre-Treatment optimizations may be made to the type of biomass and any additives to generate the best yield of C5 non-condensables to blend with the gasoline product to raise its octane rating. Blended versions of multiple types of biomass may be used to give a better liquid fuel, such as gasoline product. Chemicals and additives such as ash may be added to the biomass supplied to the torrefaction unit 212.

The char from the torrefaction unit 212 is fed on a mechanical or pneumatic conveyer system to the particle size reduction unit 226, in which the char is turned into biomass particles and then pneumatically fed into the biomass gasifier 214. A control system for the torrefaction unit 212 thermally decomposes the biomass until the char contains preferably 60-70% of an original mass of the biomass and preferably 80-85% of carbon of an original amount of the biomass fed into the torrefaction unit 212. Thus, during the thermal decomposition of the biomass in the torrefaction unit 212 in the first zone, the condensable materials, and non condensable materials contain roughly 10 to 25% and preferably 15-20% of the carbon atoms 20 to 50% and preferably 30-40% of a mass of the biomass. The char, the condensable materials, and the non condensable gases are segregated into separate areas inside the torrefaction unit 212 and collected from the torrefaction unit 212 to be routed to the next components.

The particle size reduction unit 226 that receives the char may be at least one of 1) a mechanical cutting device, 2) a shearing device, 3) a pulverizing device, and 4) any combination of these that breaks apart the biomass. A series of perforated filters in the particle size reduction unit 226 may grind, shear, or pulverize the partially pyrolyzed biomass from the torrefaction unit 212 to control the particle size of the biomass to have an average particle size between preferably 10 um to 50 um and in general 0.1 um to 1000 um. The torrefaction unit 212 supplies partially pyrolyzed biomass to the particle size reduction unit 226 and the torrefaction of the partially pyrolyzed biomass reduces the energy required by, for example, a grinding device to grind the biomass to the controlled average particle size between 10 um to 50 um. A 10 um biomass particle size is around the smallest particle size to readily absorb radiant heat while also being small enough to almost immediately vaporize or flash during the biomass gasification reaction.

The monitoring equipment and the control system in the torrefaction unit 212 are configured to feed the catalytic converter 216 with the collected non-condensable gases (CO, CO2, H2, and CH4) in the appropriate percentages to optimize production of syngas components from the catalytic converter 216. The catalytic converter 116 has monitoring equipment to analyze exhaust gases for their composition. All or a portion of the non-condensable materials can be recycled by a three way valve directly back into the input of the biomass gasifier 214 based on the monitoring equipment's analysis of their composition in order to be reacted along with the biomass particles made from the char in the biomass gasifier 214. Another control system controls the feed of the syngas components from the biomass gasifier 214 and catalytic converter 216 to combine to have the proper ratio of 2.3 to 2.7 hydrogen to carbon monoxide moles to the combined input for the methanol synthesis reactor to generate methanol for the MTG reactor to generate high octane gasoline.

Thus, the non-condensables materials may be re-cycled by a three way valve directly back into the input of the biomass gasifier 214 based on the monitoring equipment's analysis of their composition in order to be reacted with the biomass particles made from the char. Additionally, the exit gases from the catalytic converters 216 can be recycled by a three way valve to the input of the biomass gasifier 214 based on the monitoring equipment's analysis of their composition. The catalytic converters 216 are used to produce syngas using the non-condensable gases in desired percentages.

In parallel to the biomass gasifier 214 and catalytic converters 216 supplying syngas products to the methanol synthesis reactor, the torrefaction unit 212 collects and then routes the condensable materials including C5+ hydrocarbons to the gasoline blending unit to increase both the RIN credits and an octane rating of a blended gasoline product. Thus, a portion of the torrefaction off gases containing at least C5+ hydrocarbons are blended with gasoline generated from the syngas gas components produced from the thermal decomposition of the biomass in the first two zones. The area, such as a chamber, in the torrefaction unit 212 collects and sends a stream of the condensable materials including the C5+ hydrocarbons, H2O, and some C4 hydrocarbons through a supply line to a water knockout unit and a filtration/separation unit to remove non-beneficial components from the stream of condensable materials to the gasoline. After the filtration, the gasoline blending unit blends the C5+ hydrocarbons and some C4 hydrocarbons into the blended gasoline product.

A solids separator removes the ash from the gas stream exiting the biomass gasifier 214 to send syngas to the combined input of the one or more methanol synthesis reactors.

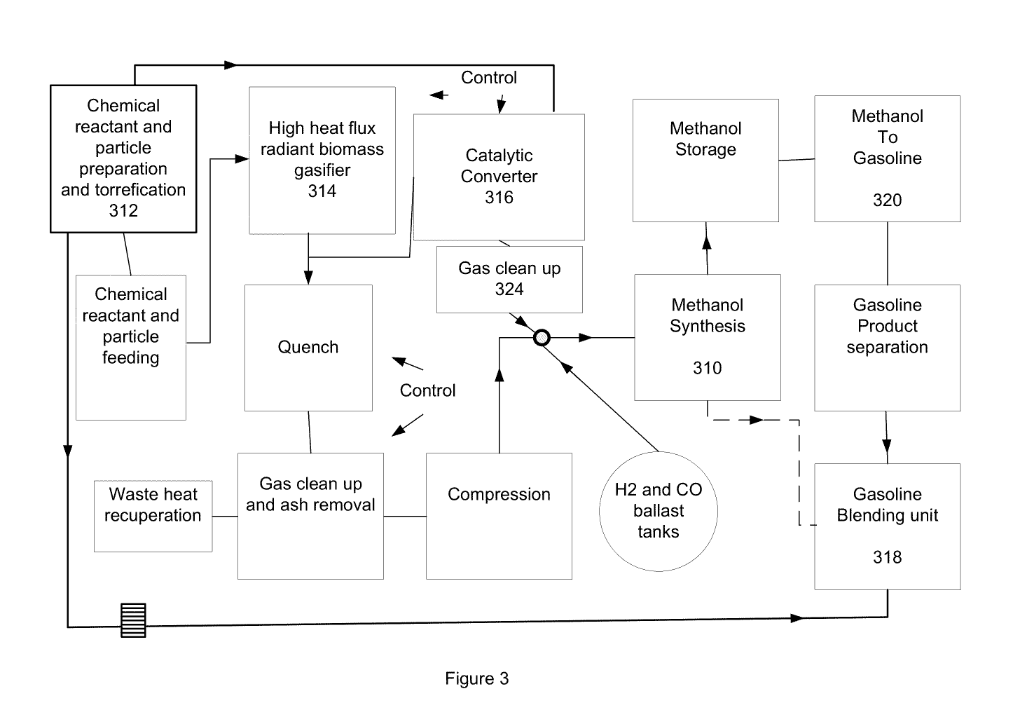

FIG. 3 illustrates a flow schematic of an embodiment of the syngas to methanol to gasoline process.

The biomass gasifier has a gas clean up section to remove ash, sulfur, water, and other contaminants from the syngas gas stream exiting the biomass gasifier 314. The syngas is then compressed to the proper pressure needed for methanol synthesis. The syngas from the catalytic converter 316 may connect upstream or downstream of the compression stage.

The synthesis gas of H2 and CO from the gasifier and the catalytic converter 316 exit gases are sent to the common input to the one or more methanol synthesis reactors. In addition, small ballast type tanks at higher pressure than system pressure, one filled with H2 and another filled with CO have an input located at the common input to the one or more methanol synthesis reactors. The exact ratio of Hydrogen to Carbon monoxide can be optimized by a control system receiving analysis from monitoring equipment on the compositions of syngas exiting the biomass gasifier 314 and catalytic converters 316 and causing the ballast tanks to insert H2 or CO to optimize the ratio. The methanol produced by the one or more methanol synthesis reactors is then processed in a methanol to gasoline process.

Note in an embodiment, a collection chamber in the methanol synthesis reactor 310 is used to collect higher alcohols having two or more carbon atoms per molecule formed as byproducts of the methanol synthesis process conducted within methanol synthesis reactor. A supply line from the collection chamber supplies these higher alcohols to the gasoline blending unit 318 as a gasoline additive to the gasoline produced from the MTG reactor 320 to boost an octane rating of the blended gasoline from the gasoline blending unit 318.

Note, the integrated plant can also use other proven catalytic processes for syngas conversion to fuels and chemicals and from the non-condensable gases from the torrefied biomass. For example, the process of converting CO and H2 mixtures to liquid hydrocarbons over a transition metal catalyst has become known as the Fischer-Tropsch (FT) synthesis. Another potential catalytic conversion of biomass-based synthesis gas is to mix higher alcohols such as 1-butanol, 1-hexanol, n-propanol, etc. having two or more carbon atoms, compared to methanol (CH3OH) which has only one. Higher alcohols or methanol mixed with higher alcohols would be better than straight methanol as a gasoline additive to boost octane, avoiding certain drawbacks of straight methanol. Higher alcohols form as byproducts of both Fischer-Tropsch and methanol synthesis. The liquid fuel produced in the integrated plant may be gasoline or another such as diesel, jet fuel, or some alcohols.

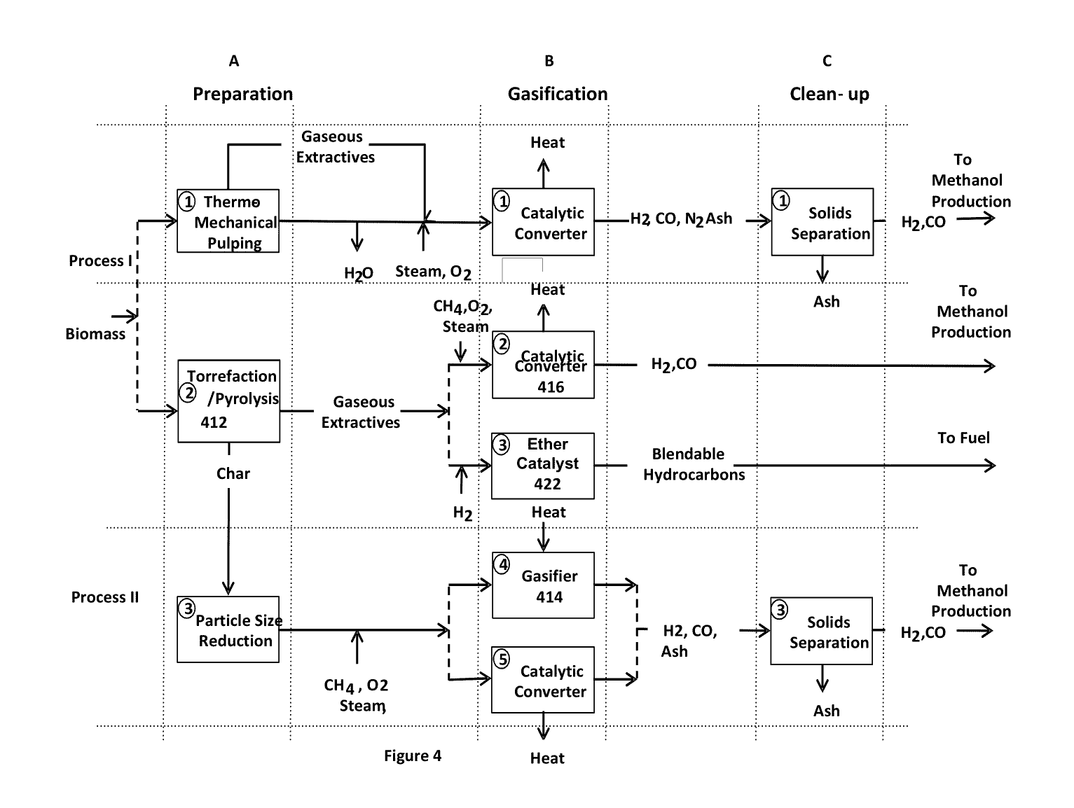

FIG. 4 illustrates a flow schematic of an embodiment of the multiple zone integrated plant. The plant uses any combination of the three ways to generate syngas for methanol production. The torrefaction of biomass and feeding of the off gases to a catalytic converter 416 can generate hydrogen and carbon monoxide for methanol production. The biomass gasifier 414 gasifies biomass at high enough temperatures to eliminate a need for a catalyst to generate hydrogen and carbon monoxide for methanol production. Alternatively, a lower temperature catalytic conversion of particles of biomass may be used to generate hydrogen and carbon monoxide for methanol production. A thermal mechanical pulping process may be used to generate hydrogen and carbon monoxide for methanol production. The torrefaction off gas of condensable hydrocarbons may be used in gasoline blending to increase the octane of the final gasoline product.

The torrefaction unit 412 may have its own internal several discrete heating stages. Each heating stage is set at a different operating temperature, rate of heat transfer, and heating duration, within the unit in order to be matched to optimize a composition of the non-condensable gases and condensable volatile material produced from the biomass in that stage of the torrefaction unit 412. Each stage has one or more temperature sensors to supply feedback to a control system for the torrefaction unit 412 to regulate the different operating temperatures and rates of heat transfer within the unit.

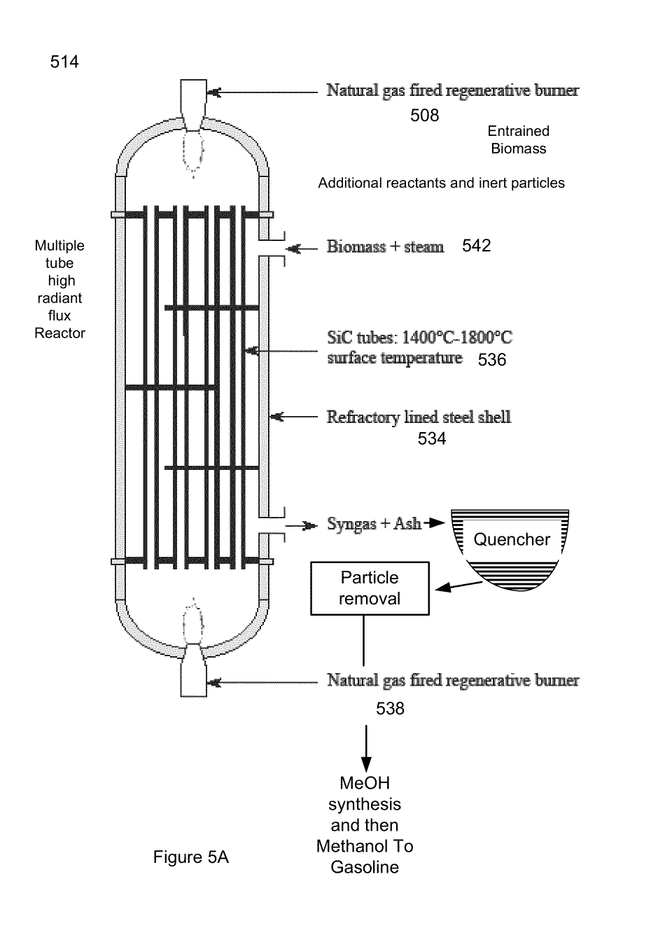

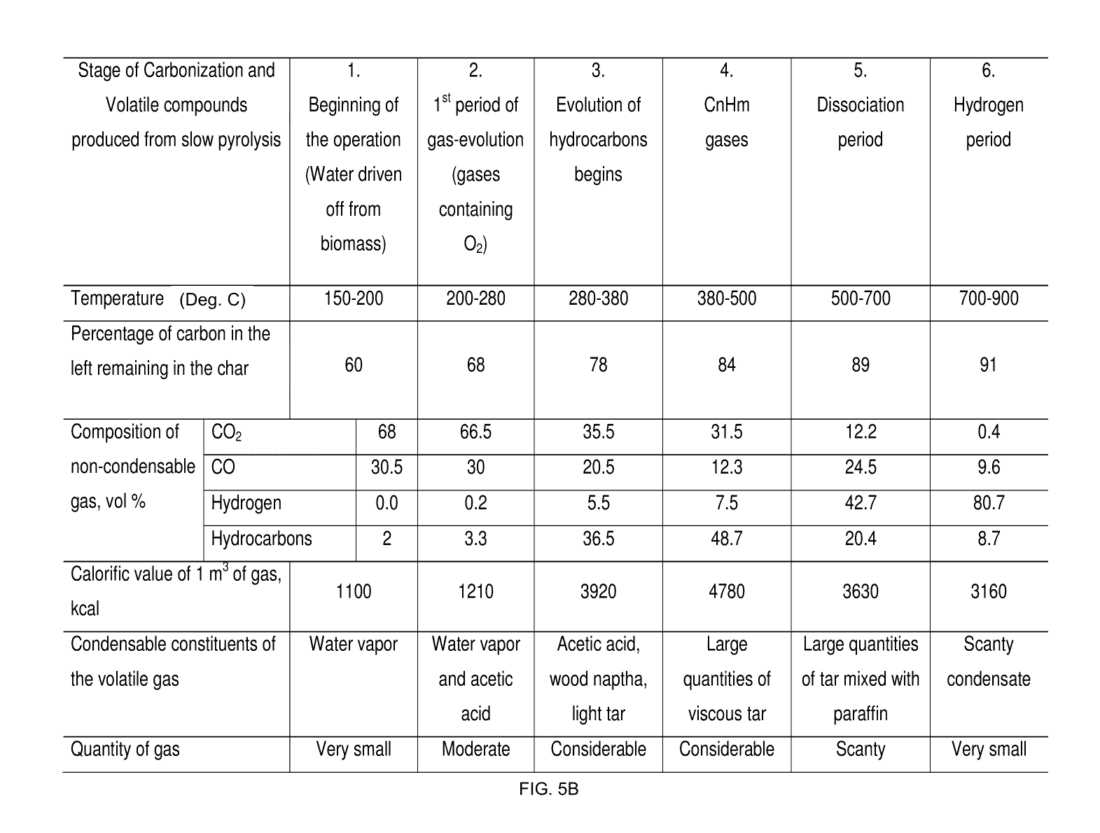

Volatiles and char may be produced by slow pyrolysis of wood via the process as follows:
The compositions and yields of volatile products are different in different temperature ranges. Insert all biomass materials
The composition of volatile products from hardwoods is essentially the same in other hardwoods, as the volatiles from softwoods are essentially comparable as other soft woods, but volatiles from softwoods differ from volatiles from hardwoods.
Slow pyrolysis at moderate temperatures is preferred to maximize the production of gas and char.
Rapid pyrolysis at high temperatures is preferred to maximize the production of liquid and minimize char.
The process is endothermic up to approximately 280° C., at which point an exothermic reaction begins and continues to a temperature of approximately 380° C., where the process once again trends back to endothermic.
   The stages of carbonization of wood in six phases in an example torrefaction unit are summarized in Table 1 in FIG. 5B. A separation of the mixture of volatile materials occurs in these six stages.

The effects of flash, fast, and slow pyrolysis differ on the composition of volatile products obtained at different temperature ranges, room temperature-300° C., 300-400° C., and 400-500° C. Within a specific temperature range, flash, fast, and slow pyrolysis produce different volatile products within each range, consistent with the stages, but the overall list of all the compounds obtained from wood by using different heating rates were the same. Distillation curves for a composition of extractives from hardwood, softwood, and TMP pulp may differ in the percent generation of Non-condensables, Condensables, and Char at different temperatures, rates of heating, and durations of heating. Thus, softwood can be heated in different stages such as 200 degrees C., 200-300, 300-400, 400-500, 500-600, 600-700, and 700 to 800. Hardwood and Thermal mechanical pulp can also be heated in these different stages to obtain a different composition and yield of extractives from the hardwood, softwood, and TMP pulp. The volatile materials from these different biomass types and processes may be used as feed stocks.

Thus, the torrefaction unit 412 may utilize the series of stages comparable to the example carbonization described in Table 1 above to produce the mixtures of volatiles at multiple temperatures to give an optimum composition and yield at each temperature condition. Monitoring equipment collects volatiles across the complete range of temperature conditions for each feedstock and analyzes distillation to generate a distillation curve. Multiple feed stocks can be used: (1) standard softwoods, (2) standard hardwoods, and (3) thermo-mechanical pulp. Technical and economic process optimizations are used in the environment of an integrated plant to optimize the appropriate degree of torrefaction and volatile production to provide the most profitable design and operating conditions for the overall plant. These volatiles from the torrefied material may be used as feedstock for a radiant particle reactor that acts as the biomass gasifier, the gasoline blending unit, and/or for a catalytic converter 416 process.

Torrefaction can also improve the grinding and feeding properties of biomass materials so they can be co-fed into a gasifier, and the volatiles evolved during the torrefaction process can be burned to provide the process heat rather than mixed back into the process. In addition to the improvements in grindability, qualitative results from these tests have shown the use of torrefied material may have the beneficial effects versus raw biomass of increasing process gas temperatures through more effective heat transfer of radiation to the particles entrained with the gas, increased gasifier productivity, and improved process hygiene via decreased production of tars and C2+ olefins.

On site, the biomass can be stored in the open for the most part. Use of torrefied material for feed reduces a need for a humidity-controlled housing environment to ensure proper H2O content of biomass for gasification because the torrefaction just prior to being ground will bring the biomass to the desired H2O content.

The torrefaction unit 112 is geographically located on the same site as the ultra-high heat flux chemical reactor and configured to subject the biomass to partial pyrolysis to generally heat the biomass to a temperature of, for example, 300 degrees C., with recouped waste heat from the gasification reaction.

The torrefaction makes the biomass 1) brittle and easier for grinding, 2) dryer, less sticky, and easier to feed in a conveying system, and 3) it produces off gases from the torrefaction process. The off gases from the torrefaction of the biomass are used for one or more of the 1) entrainment carrier gas, 2) an energy source for the steam boilers for steam generation, 3) a gas for the gas-fired regenerative burners, 4) utilize torrefaction off-gasses for gasoline blending 5) off gases for syngas generation, and/or 6) a reactant feed input into a SMR reactor. The torrefaction of the biomass may occur in different atmospheres to modify the reactivity or conversions of the biomass. A best particle size of biomass particles may include fibers of a particle size to effectively absorb radiation at 10 um.

The torrefaction unit 412 and then the particle size reduction unit are performed via this thermal/chemical process as a latest point in process. The torrefaction unit 412 may have a collection chamber to collect the char to be fed to a particle size reduction unit in line with the torrefaction unit 412 in the first zone. The particle size reduction unit is configured to feed the biomass particles generated from the char into an inline feeding system for the biomass gasifier 414 in the second zone. The torrefaction unit 412 heats the biomass to make the residual char to achieve a desired moisture content indicated by a moisture sensor, and then the particle size reduction unit uses a set of filters on the torrefied char to achieve a consistent output of biomass particles of preferably an average particle size between 10 um to 50 um and in general 0.1 um to 1000 um. The biomass particles of the average particle size are fed by the inline feeding system into the biomass gasifier 414 and due to the average particular size of the biomass particles and operating temperature of the reactor the particles almost immediately flash to ash and gaseous components, which improves a yield of syngas components generated per amount of biomass supplied and minimizes an amount of residual tar generated in a biomass gasification reaction conducted within the biomass gasifier 414. The control system for the biomass gasifier 414 maintains the operating temperature greater than 1000 degrees C.

The torrefaction unit 412 collects and produces the char to be fed to a particle size reduction unit in line with the torrefaction unit 412 in the first zone. The torrefaction unit 412 is configured to receive two or more types of biomass feed stocks, where the different types of biomass including 1) soft woods, 2) hard woods, 3) grasses, 4) plant hulls, and 5) any combination that are blended and pyrolyzed into a homogenized torrefied feedstock within the torrefaction unit 412 that is subsequently collected and then fed into the biomass gasifier 414. The torrefaction unit 412 assists in making a biomass feed system that is feedstock flexible without changing out the design of the feed supply equipment via at least particle size control of the biomass particles produced from particle size reduction unit in line with the torrefaction unit 412 in the first zone and a multiple stage torrefaction process itself. An entrained-flow biomass feed system supplies the biomass particles in a carrier gas to the radiant heat transfer reactor. The feed system uses a carrier gas to transport the particles of wood into the biomass gasifier 414 reactor, and then the biomass gasifier reactor 414 gasifies the particles of wood/biomass.

As discussed, alternative ways exist to create the syngas. The potentially treated biomass is supplied to a Thermo-Mechanical Pulping unit, water is removed from the pulp, and the pulp is exposed to steam and oxygen and supplied to a catalytic converter 116. The catalytic converter 116 produces H2, CO, and Ash. A solids separator removes the Ash from the gas stream. Synthesis gas of H2 and CO from the gasifier and the catalytic converter 116 exit gases are sent to methanol synthesis reactors 110.

Additional application of technologies may produce liquid fuels directly from biomass or via syngas and gas to liquids technology. A matrix of alternative technologies from multiple industries in one or more novel combinations has been proposed as an alternative means of producing syngas and liquid fuels, possibly utilizing the gasifier as a unit operation. The industries and technologies included in the matrix are:

| Industry | Technologies |
|---|---|
| Pulp and paper | Thermo-mechanical pulping |
| Electrical utility/power generation | Torrefaction |
| Petro-chemical | Hydro-treating, catalytic processing |
| Automotive | Catalytic processing of gases |
| Alternative fuels | Gasification of solids, reactive flash |
| | volatilization |

These alternative technologies provide opportunities to optimize the total system of converting solid biomass to syngas, and ultimately liquid fuels, by segmenting the overall process and utilizing technologies uniquely suited to the requirements of each segment:

| Process Segment | Technology | Primary Purpose |
|---|---|---|
| Biomass preparation | Thermo-mechanical pulping | Particle size reduction |
| | Torrefaction | Particle size reduction |
| | | Liquid and gaseous |
| | | extractive production |
| Gasification | Radiant heat particle reactor | Thermal gasification of |
| | | biomass solids |
| | Non-radiant heat gasifiers | Thermal gasification of |
| | | solids |
| | Steam reformation of | Catalytic gasification of |
| | cellulose by Reactive | solids |
| | flash volatilization | |
| Non-condensable | Catalytic reaction | Produce syngas from |
| gases | | non-condensable H/Cs |
| Condensable gases | Catalytic reaction | Use ether catalyst to |
| to fuel | | convert |
| | | Alcohol + Alcohol -> |
| | | Ether + H20 |
| | | Alcohol + Olefins -> |
| | | Ether |
| Wood Distillation | | |

Biomass, as Wood feed stocks, may be processed to yield volatile materials that can be utilized in the finished gasoline product in order to claim the maximum level of valuable RIN credits from the raw feed. The reaction conditions may be varied for the wood distillation to produce non-condensable and condensable volatiles that can be incorporated into the syngas and finished gasoline product with the minimum amount of additional processing.

FIG. 5A illustrates a flow schematic of an embodiment for the radiant heat chemical reactor configured to generate chemical products including synthesis gas products. The multiple shell radiant heat chemical reactor 514 includes a refractory vessel 534 having an annulus shaped cavity with an inner wall. The radiant heat chemical reactor 514 has two or more radiant tubes 536 made out of a solid material. The one or more radiant tubes 536 are located inside the cavity of the refractory lined vessel 534.

The exothermic heat source 538 heats a space inside the tubes 536. Thus, each radiant tube 536 is heated from the inside with an exothermic heat source 538, such as regenerative burners, at each end of the tube 536. Each radiant tube 536 is heated from the inside with fire and gases from the regenerative burners through heat insertion inlets at each end of the tube 536 and potentially by one or more heat insertion ports located in between the two ends. Flames and heated gas of one or more natural gas fired regenerative burners 538 act as the exothermic heat source supplied to the multiple radiant tubes at temperatures between 900° C. and 1800° C. and connect to both ends of the radiant tubes 536. Each tube 536 may be made of SiC or other similar material.

One or more feed lines 542 supply biomass and reactant gas into the top or upper portion of the chemical reactor 514. The feed lines 542 for the biomass particles and steam enter below the entry points in the refractory lined vessel 534 for the radiant tubes 536 that are internally heated. The feed lines 542 are configured to supply chemical reactants including 1) biomass particles, 2) reactant gas, 3) steam, 4) heat transfer aid particles, or 5) any of the four into the radiant heat chemical reactor. A chemical reaction driven by radiant heat occurs outside the multiple radiant tubes 536 with internal fires. The chemical reaction driven by radiant heat occurs within an inner wall of a cavity of the refractory lined vessel 534 and an outer wall of each of the one or more radiant tubes 536.

The chemical reaction may be an endothermic reaction including one or more of 1) biomass gasification (CnHm+H20→CO+H2+H20+X), 2) and other similar hydrocarbon decomposition reactions, which are conducted in the radiant heat chemical reactor 514 using the radiant heat. A steam (H2O) to carbon molar ratio is in the range of 1:1 to 1:4, and the temperature is high enough that the chemical reaction occurs without the presence of a catalyst.

The biomass gasifier 514 has a radiant heat transfer to the particles flowing through the reactor design with a rapid gasification residence time, of the biomass particles of 0.1 to 5 seconds and preferably less one second, of biomass particles and reactant gas flowing through the radiant heat reactor. Primarily radiant heat from the surfaces of the radiant heat reactor and particles entrained in the flow heat the particles and resulting gases to a temperature in excess of generally 1000 degrees C. and preferably 1300° C. to produce the syngas components including carbon monoxide and hydrogen, as well as keep produced methane at a level of ≦1%, of the compositional makeup of exit products, minimal tars remaining in the exit products, and resulting ash. The torrefied biomass particles used as a feed stock into the radiant heat reactor design conveys the beneficial effects of increasing and being able to sustain process gas temperatures of excess of 1300 degrees C. through more effective heat transfer of radiation to the particles entrained with the gas, increased gasifier yield of generation of syngas components of carbon monoxide and hydrogen for a given amount of biomass fed in, and improved process hygiene via decreased production of tars and C2+ olefins. The control system for the radiant heat reactor matches the radiant heat transferred from the surfaces of the reactor to a flow rate of the biomass particles to produce the above benefits.

The control system controls the gas-fired regenerative burners 538 to supply heat energy to the chemical reactor 514 to aid in causing the radiant heat driven chemical reactor to have a high heat flux. The inside surfaces of the chemical reactor 514 are aligned to 1) absorb and re-emit radiant energy, 2) highly reflect radiant energy, and 3) any combination of these, to maintain an operational temperature of the enclosed ultra-high heat flux chemical reactor 514. Thus, the inner wall of the cavity of the refractory vessel and the outer wall of each of the one or more tubes 536 emits radiant heat energy to, for example, the biomass particles and any other heat-transfer-aid particles present falling between an outside wall of a given tube 536 and an inner wall of the refractory vessel. The refractory vessel thus absorbs or reflects, via the tubes 536, the concentrated energy from the regenerative burners 538 positioned along on the top and bottom of the refractory vessel to cause energy transport by thermal radiation and reflection to generally convey that heat flux to the biomass particles, heat transfer aid particles and reactant gas inside the chemical reactor. The inner wall of the cavity of the thermal refractory vessel and the multiple tubes 536 act as radiation distributors by either absorbing solar radiation and re-radiating it to the heat-transfer-aid particles or reflecting the incident radiation to the heat-transfer-aid particles. The radiant heat chemical reactor 514 uses an ultra-high heat flux and high temperature that is driven primarily by radiative heat transfer, and not convection or conduction.

Convection biomass gasifiers used generally on coal particles typically at most reach heat fluxes of 5-10 kW/m̂2. The high radiant heat flux biomass gasifier will use heat fluxes significantly greater, at least three times the amount, than those found in convection driven biomass gasifiers (i.e. greater than 30 kW/m̂2). Generally, using radiation at high temperature (>950 degrees C. wall temperature), much higher fluxes (high heat fluxes greater than 80 kW/m̂2) can be achieved with the properly designed reactor. In some instances, the high heat fluxes can be 100 kW/m̂2-250 kW/m̂2.

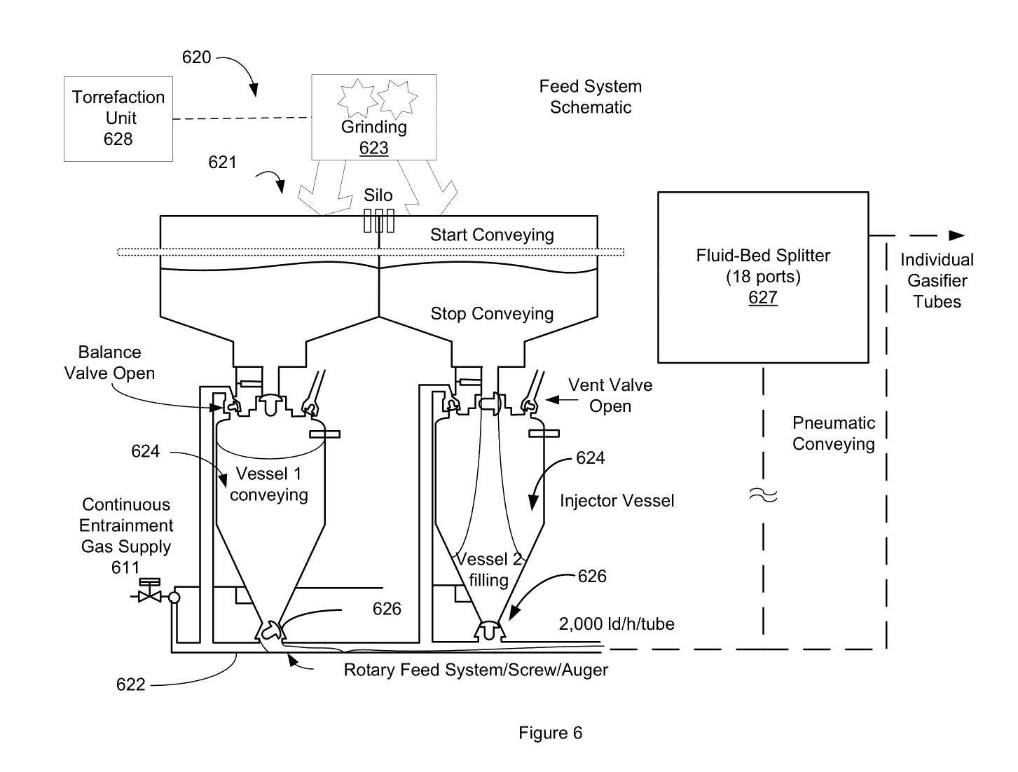

FIG. 6 illustrates a block diagram of embodiments for an entrained-flow biomass feed system that supplies the biomass particles and heat-transfer-aid particles in a carrier gas to the chemical reactor.

The high heat flux reactor and associated integrated system may also include a grinding system 623. The grinding system 623 has a grinding device that is at least one of 1) a mechanical cutting device, 2) a shearing device, 3) a pulverizing device, and 4) any combination of these that breaks apart the biomass, and a series perforated filters in the entrained-flow biomass feed system. The grinding device and perforated filters grind the partially pyrolyzed biomass from the torrefaction unit 628 to control the particle size of the biomass to be between 10 um and 1000 um. The torrefaction unit 628 is geographically located on the same site as the radiant heat driven chemical reactor and supplies partially pyrolyzed biomass to the grinding system 623. The torrefaction of the partially pyrolyzed biomass reduces the energy required by the grinding device to grind the biomass to the controlled particle size between 10 um and 1000 um. The off gases from the torrefaction of the biomass can be used for the uses discussed previously. The feedstock flexibility of being able to use multiple types of biomass without redesigning the feed and reactor process clearly gives an economic advantage over processes that are limited to one or a few available feed stocks.

The entrained-flow biomass feed may go through a flow splitter 627 into the refractory vessel or directly go from a pressurized lock hopper pair 624 into the refractory vessel. The entrained-flow biomass feed system 620 can include a pressurized lock hopper pair 624 that feeds the biomass to a rotating metering feed screw 622 and then into an entrainment gas pipe at the exit 626 of the lock hopper pair. The particles of the biomass are distributed into multiple entrainment gas lines by a flow splitter 627 to feed the two or more radiant tubes making up the chemical reactor.

In an embodiment, the high heat flux reactor and associated integrated system may also include the entrained-flow biomass feed system 620 having one or more lock-hopper pairs 624 equipped with a single multi-outlet feed splitter 627 that simultaneously feeds the particles of the biomass in pressurized entrainment gas lines into two or more tubes of the chemical reactor. The gas source 611 may also supply pressurized entrainment gas in the form of recycled carbon dioxide from an amine acid gas removal step in the hydrocarbon fuel synthesis process, steam, or some other carrier gas. The multi-outlet feed splitter 627 provides and controls an amount of distribution of the particles of the biomass in the one or more pressurized entrainment gas lines that feed particles around the two or more radiant tubes in the chemical reactor.

The feed system may be configured to supply heat-transfer-aid particles and chemical reactants into the gasification reactor. The feed system may be configured to blend the biomass materials in the dispersion unit with the heat-transfer-aid particles prior to feeding and entraining them into the chemical reactor. The feed system may be configured to blend the heat-transfer-aid particles with the reactant gas in the entrainment gas lines as well.

The recycled ash from the separator in the syngas clean up section is blended with biomass particles in the feed system to generate additional heat from both any remaining combustion and as a radiation absorption particle in order to fully utilize the remaining carbon atoms in the ash.

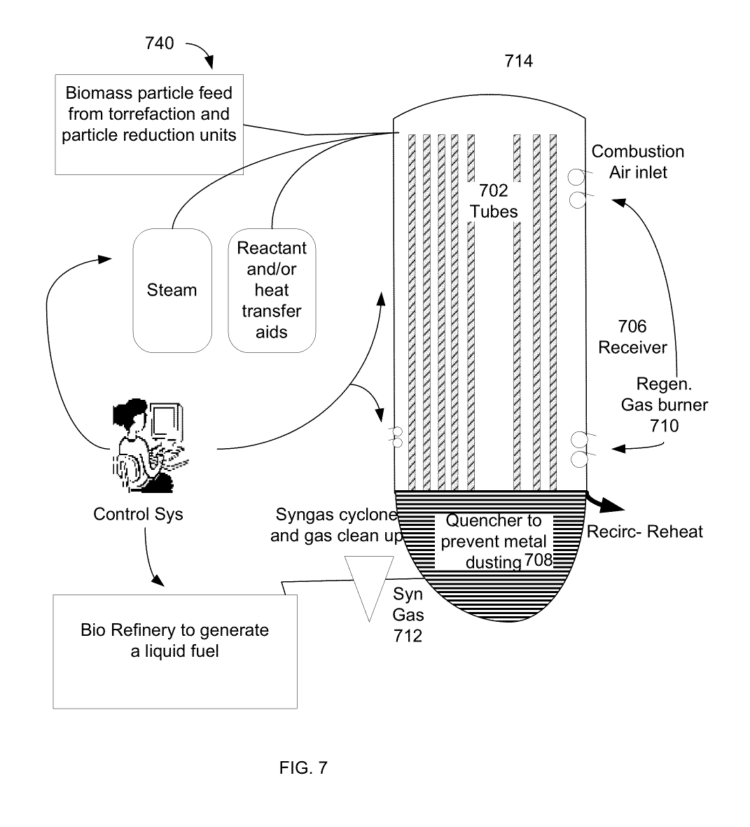

FIG. 7 illustrates a diagram of an embodiment of the integrated multiple zone bio-refinery with multiple control systems that interact with each other. In such a system, radiant heat energy may be provided to the chemical reactor 714. In this example, the chemical reactor may be heated by two or more sets of the gas-fired regenerative burners 710.

An entrainment carrier gas system supplies carrier gas for the particles of biomass in the feed system to the chemical reactor. The other chemical reactants, heat transfer aid particles, oxygen, and/or steam may also be delivered to the radiant tubes. As illustrated, chemical reactants, including biomass particles, may flow into the chemical reactor 702 and syngas flows out 712. The quench unit 708 may be used to rapidly cool the reaction products and prevent a back reaction into larger molecules.

The computerized control system may be multiple control systems that interact with each other. The computerized control system is configured to send a feed demand signal to feed system's to control an amount of 1) radiant tube sets to be fed particles of biomass in the chemical reactor, 2) amount of gas fired regenerative burners supplying heat, 3) rate at which particular gas fired regenerative burners supply heat, and 4) any combination of these based on control signals and the temperature measured for the chemical reactor. The control system may rely on feedback parameters including temperature of the reactor as well as feed forward parameters including anticipated changes in heat in from the burners and heat out from changes in an amount of chemical reactants and carrier gas being passed through the radiant tubes 702.

In general, the high heat transfer rates of the radiant tubes and cavity walls maintained by the control system allow the particles of biomass to achieve a high enough temperature necessary for substantial tar destruction and gasification of greater than 90 percent of the biomass particles into reaction products including the hydrogen and carbon monoxide gas in a very short residence time between a range of 0.01 and 5 seconds.

The control system keeps the reaction temperature in the chemical reactor high enough based on temperature sensor feedback to the control system to avoid the need for any catalyst to cause the chemical reaction occurring within the chemical reactor but allowing the temperature at or near the exit to be low enough for a hygiene agent supply line to inject hygiene agents to clean up the resultant product gas by removing undesirable compositions from the resultant product gas, promote additional reactions to improve yield, and any combination of these two, all while keeping the exit temperature of the chemical reactor greater than 900 degree C. to avoid tar formation in the products exiting the chemical reactor.

The control system may be configured to maintain the reaction temperature within the chemical reactor based upon feedback from a temperature sensor at at least 1200 degrees C. to eliminate the need for a catalyst for the chemical reactions as well as overdrive the endothermic reactions including the steam methane reforming and the steam ethane reforming, which are equilibrium limited; and thereby improve the equilibrium performance for the same amount of moles of reactant feedstock, to increase both yield of resultant gaseous products and throughput of that reactant feedstock.

The control system for the torrefication unit, catalytic converters and biomass gasifier control the ratio and content of the syngas going to the methanol synthesis reactor and interact with the other control systems in the integrated plant.

The control systems of the reactor and liquid fuel plant 720, such as a Methanol to Gasoline synthesis plant, may have bi-directional communications between the chemical reactor and the liquid fuel plant, such as a methanol plant. For example, when a subset of tubes needs to be adjusted out for maintenance or due to a failure, then the integrated plant can continue to operate with increase biomass and entrainment gas flow through the chemical reactor to keep a steady production of syngas for conversion into a liquid fuel. Changing entrainment gas pressure in the radiant tubes can also be used to increase/decrease the heat sink effect of the biomass and gas passing through the tubes.

The integrated chemical plant 720 converts the supplied chemical reactants, such as particles of biomass, into gasoline in the integrated chemical plant as follows. The hydrogen and carbon monoxide products from the chemical reactor are converted in an on-site methanol synthesis plant to methanol, and the methanol from the methanol synthesis plant is converted to gasoline in a methanol-to-gas process. The on-site chemical synthesis reactor, such as a methanol synthesis plant, is geographically located on the same site as the chemical reactor and integrated to receive the hydrogen and carbon monoxide products in the form of syngas. The on-site chemical synthesis reactor has an input to receive the syngas, which contains the hydrogen and carbon monoxide products from the chemical reactor, and then is configured to use the syngas in a hydrocarbon synthesis process to create a liquid hydrocarbon fuel or other chemical. The methanol production from syngas production is decoupled from being directly tied the momentary rate of syngas production by storing excess syngas, supplying supplemental syngas, or idling methanol reactors.

The control system has algorithms and operational routines established to tolerate transient flow of syngas operation. Also, the energy source for the reactor may be solar, nuclear, LPG as well as methane.

Next, the various algorithms and processes for the control system may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below. In general, the program modules may be implemented as software instructions, Logic blocks of electronic hardware, and a combination of both. The software portion may be stored on a machine-readable medium and written in any number of programming languages such as Java, C++, C, etc. The machine-readable medium may be a hard drive, external drive, DRAM, Tape Drives, memory sticks, etc. Therefore, the algorithms and controls systems may be fabricated exclusively of hardware logic, hardware logic interacting with software, or solely software.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in electronic circuitry, or a combination of both. The control system uses the software in combination with integrated logic chips in hardware to control the system.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown the invention is not to be limited to these embodiments. For example, the recuperated waste heat from various plant processes can be used to pre-heat combustion air, or can be used for other similar heating means. Regenerative gas burners or conventional burners can be used as a heat source for the furnace. Alcohols C1, C2 and higher as well as ethers that are formed in the torrefication process may be used as a high value in boosting the octane rating of the generated liquid fuel, such as gasoline. Biomass gasifier reactors other than a radiant heat chemical reactor may be used. The Steam Methane Reforming may be/include a SHR (steam hydrocarbon reformer) that cracks short-chained hydrocarbons (<C20) including hydrocarbons (alkanes, alkenes, alkynes, aromatics, furans, phenols, carboxylic acids, ketones, aldehydes, ethers, etc, as well as oxygenates into syngas components. The invention is to be understood as not limited by the specific embodiments described herein, but only by scope of the appended claims.

1. A system, comprising:
a multiple zone integrated plant to generate a liquid fuel product, where a first and second zone are fed in series and have a portion of their outputs that are combined in parallel to feed syngas components, including hydrogen (H2) and carbon monoxide (CO), in a proper ratio to a methanol (CH3OH) synthesis reactor, where a first zone includes a torrefication unit to pyrolyze biomass at a temperature of less than 700 degrees C. for a preset amount of time to create off gases to be used in a creation of a portion of the syngas components fed to the methanol synthesis reactor, and a second zone includes a biomass gasifier to react char particles of the biomass from the first zone in the presence of steam in a rapid biomass gasification reaction at a temperature of greater than 1000 degrees C. in less than a five second residence time in the biomass gasifier to create another portion of the syngas components fed to the methanol synthesis reactor, where a third zone includes a gasoline blending unit that is configured to blend gasoline produced from a methanol to gasoline (MTG) reactor, which receives its methanol derived from the syngas components in the proper ratio fed to the methanol synthesis reactor, where the gasoline blending unit is configured to blend the gasoline from the methanol to gasoline reactor with condensable volatile materials including C5+ hydrocarbons collected during the pyrolyzation of the biomass in the torrefication unit in the first zone; and thus, where the torrefaction unit is configured to produce and collect 1) condensable materials with significant fuel blending value, 2) char, and 3) non-condensable gases including C1-4 olefins, where the torrefaction unit is configured to route the separated products as follows 1) condensable materials with significant fuel blending value are routed to the gasoline blending unit, 2) char is routed as a feedstock for the biomass gasifier, and 3) non-condensable gases including C1-4 olefins are routed to a catalytic reactor in parallel with biomass gasifier in order to create the portion of the syngas component to be fed to the methanol synthesis reactor.

2. The system of claim 1, where the torrefaction unit has two or more areas to segregate out and then route the non-condensable gases including the C1 to C4 olefins, as well as other gases including CO, CH4, CO2 and H2, through a supply line to the catalytic converter that catalytically transform portions of the non-condensable gases to the syngas components of CO and H2 that are sent in parallel with the portion of syngas components from the biomass gasifier to a combined input to the methanol synthesis reactor, where the catalytic converter has a control system to regulate a supply of an oxygenated gas and steam along with the non-condensable gases to the catalytic converter, which produces H2, and CO as exit gases, where the catalytic converter is configured with the control system and a composition of a catalyst material inside the catalytic converter to rather than convert the supplied non-condensable gases completely into CO2 and H2O in the exit gas, the non-condensable gases, steam, and oxygenated gas are passed through the catalytic converter in a proper ratio to achieve an equilibrium reaction that favors a production of carbon monoxide (CO) and hydrogen (H2) in the exit gas.

3. The system of claim 2, further comprising:
a sulfur filter and other filters between the torrefication unit and the catalytic converter configured to receive the non-condensable gases collected and routed from the torrefaction unit and configured to remove contaminants from the stream of non-condensable gases that would inactivate or otherwise harm the catalyst material within the catalytic converter.

4. The system of claim 2, further comprising:
monitoring equipment and a first control system in the torrefication unit configured to feed the catalytic converter with the collected non-condensable gases (CO, CO₂, H₂, and CH₄) in the appropriate percentages to optimize production of syngas components from the catalytic converter, and the catalytic converter has monitoring equipment to analyze exhaust gases for their composition, where all or a portion of the non-condensable materials is recyclable by a three way valve directly back into the input of the biomass gasifier based on the monitoring equipment's analysis of their composition in order to be reacted with the biomass particles made from the char in the biomass gasifier, and a second control system controls the feed of the syngas components from the biomass gasifier and catalytic converter to combine to have the proper ratio of 2.3 to 2.7 hydrogen to carbon monoxide moles to the combined input for the methanol synthesis reactor to generate methanol for the MTG reactor to generate high octane gasoline.

5. The system of claim 1, further comprising:
a collection chamber in the methanol synthesis reactor to collect higher alcohols having two or more carbon atoms per molecule formed as byproducts of the methanol synthesis process conducted within methanol synthesis reactor and a supply line to supply the higher alcohols to the gasoline blending unit as a gasoline additive to the gasoline produced from the MTG reactor to boost an octane rating of the blended gasoline from the gasoline blending unit.

6. The system of claim 1, where char from the torrefaction unit is fed on a conveyer system to a particle size reduction unit, in which the char is turned into biomass particles and then pneumatically fed into the biomass gasifier, where a control system for the torrefaction unit thermally decomposes the biomass until the char contains preferably 60-70% of an original mass of the biomass and preferably 80-85% of carbon of an original amount of the biomass fed into the torrefaction unit; and thus, during the thermal decomposition of the biomass in the torrefaction unit in the first zone, the condensable materials, and non condensable materials contain roughly 10 to 25% and preferably 15-20% of the carbon atoms 20 to 50% and preferably 30-40% of a mass of the biomass, and the char, the condensable materials, and the non-condensable gases are segregated into separate areas inside the torrefication unit and collected from the torrefaction unit.

7. The system of claim 1, where the torrefaction unit has several discrete heating stages set at different operating temperatures and rates of heat transfer within the unit matched to optimize a composition of the non-condensable gases and condensable volatile material produced from the biomass in that stage of the torrefaction unit and each stage has one or more temperature sensors to supply feedback to a control system for the torrefaction unit to regulate the different operating temperatures and rates of heat transfer within the unit.

8. The system of claim 6, where the biomass gasifier has a radiant heat transfer to particles flowing through the reactor design with a rapid gasification residence time, of the biomass particles of 0.1 to 5 seconds and preferably less one second, of biomass particles and reactant gas flowing through the radiant heat reactor, and primarily radiant heat from the surfaces of the radiant heat reactor and particles entrained in the flow heat the particles and resulting gases to a temperature in excess of generally 1000 degrees C. and preferably 1300° C. to produce the syngas components including carbon monoxide and hydrogen, as well as keep produced methane at a level of ≦1% of the compositional makeup of exit products, minimal tars remaining in the exit products, and resulting ash, where the torrefied biomass particles used as a feed stock into the radiant heat reactor design conveys the beneficial effects of increasing and being able to sustain process gas temperatures of excess of 1300 degrees C. through more effective heat transfer of radiation to the particles entrained with the gas, increased gasifier yield of generation of syngas components of carbon monoxide and hydrogen for a given amount of biomass fed in, and improved process hygiene via decreased production of tars and C₂+ olefins, where a control system for the radiant heat reactor matches the radiant heat transferred from the surfaces of the reactor to a flow rate of the biomass particles to produce the above.

9. The system of claim 1, where the torrefaction unit has a collection chamber to collect the char to be fed to a particle size reduction unit inline with the torrefaction unit in the first zone, and particle size reduction unit is configured to feed the biomass particles generated from the char into an inline feeding system for the biomass gasifier in the second zone, where the torrefaction unit heats the biomass to make the residual char to achieve a desired moisture content indicated by a moisture sensor, and then the particle size reduction unit uses a set of filters on the torrefied char to achieve a consistent output of biomass particles of preferably an average particle size between 10 um to 50 um and in general 0.1 um to 1000 um, and then the biomass particles of the average particle size are fed by the inline feeding system into the biomass gasifier and due to the average particular size of the biomass particles and operating temperature of the reactor the particles almost immediately flash to ash and gaseous components improving a yield of syngas components generated per amount of biomass supplied and minimizing an amount of residual tar generated in a biomass gasification reaction conducted within the biomass gasifier, where the torrefaction process makes the biomass 1) into brittle char that is easier for particle size reduction into the average particle size, 2) into brittle char that is dryer, less sticky, and easier to feed into the inline feed system, and 3) produce off gases including the non-condensable gases and condensable materials, where a control system for the biomass gasifier maintains the operating temperature greater than 1000 degrees C.

10. The system of claim 1, where the torrefaction unit has a collection chamber to collect the char to be fed to a particle size reduction unit inline with the torrefaction unit in the first zone, and particle size reduction unit is configured to feed the biomass particles generated from the char into an inline feeding system for the biomass gasifier in the second zone, where the torrefaction unit is configured to receive two or more types of biomass feed stocks, where the different types of biomass including 1) soft woods, 2) hard woods, 3) grasses, 4) plant hulls, and 5) any combination that are blended and pyrolyzed into a homogenized torrefied feedstock within the torrefaction unit that is subsequently collected and then fed into the biomass gasifier, where the torrefaction unit assists in making a biomass feed system that is feedstock flexible without changing out the design of the feed supply equipment via at least particle size control of the biomass particles produced from particle size reduction unit inline with the torrefaction unit in the first zone and a multiple stage torrefication process itself.

11. The system of claim 1, where in parallel to the biomass gasifier and catalytic converters supplying syngas products to the methanol synthesis reactor, the torrefaction unit has an area to collect and then route the condensable materials including C5+ hydrocarbons to the gasoline blending unit to increase an octane rating of a blended gasoline product; and thus, a portion of the torrefication off gases containing at least C5+ hydrocarbons are used to blend with gasoline generated from the syngas gas components produced from the thermal decomposition of the biomass in the first two zones, where the area in the torrefication unit collects and sends a stream of the condensable materials including the C5+ hydrocarbons, H2O, and some C4 hydrocarbons through a supply line to a water knockout unit and a filtration/separation unit to remove non-beneficial components to the gasoline from the stream of condensable materials, where after the filtration, the gasoline blending unit blends the C5+ hydrocarbons and some C4 hydrocarbons into the blended gasoline product.

12. A method for generating a liquid fuel product in an integrated multiple zone plant, comprising:
supplying syngas components to a methanol (CH3OH) synthesis reactor from outputs of a first zone containing a torrefaction unit and a second zone containing a biomass gasifier that are combined in parallel and that thermally decompose biomass at different operating temperatures;
feeding char particles of the biomass generated in the first zone to the biomass gasifier in the second zone;
producing gasoline via a methanol to gasoline process in a third zone, which receives its methanol derived from the syngas components fed to the methanol synthesis reactor; and
blending the gasoline with condensable volatile materials including C5+ hydrocarbons collected during the pyrolyzation of the biomass in the torrefaction unit in the first zone in order to increase an octane rating of the blended gasoline.

13. The method of claim 12, further comprising:
producing and collecting 1) condensable materials with significant fuel blending value, 2) char, and 3) non-condensable gases including C1-4 olefins in the torrefaction unit in the first zone;
segregating out the non-condensable gases including the C1 to C4 olefins, as well as other gases including CO, CH4, CO2 and H2, and routing them to a catalytic converter that catalytically transform portions of the non-condensable gases to the syngas components of CO and H2 that are sent in parallel with the portion of syngas components from the biomass gasifier to a combined input to the methanol synthesis reactor;
regulating a supply of an oxygenated gas and steam along with the non-condensable gases to the catalytic converter, which produces H2, and CO as exit gases; and
converting the supplied non-condensable gases, steam, and oxygenated gas in the catalytic converter in a proper ratio to achieve an equilibrium reaction that favors a production of carbon monoxide (CO) and hydrogen (H2) in the exit gas.

14. The method of claim 13, further comprising:
filtering out sulfur based compounds and other contaminants from the stream of non-condensable gases between the torrefication unit and the catalytic converter that would inactivate or otherwise harm the catalyst material within the catalytic converter.

15. The method of claim 13, further comprising:
controlling the non-condensable gases (CO, CO₂, H₂, and CH₄) in the appropriate percentages to optimize production of syngas components from the catalytic converter in its exhaust gases; and
analyzing the exhaust gases for their composition from the catalytic converter and the syngas components from the biomass gasifier to combine to have a proper ratio of 2.3 to 2.7 hydrogen to carbon monoxide moles to the combined input for the methanol synthesis reactor to generate methanol for the MTG process to generate the high octane gasoline, where all or a portion of the non-condensable materials is recyclable by a three way valve directly back into the input of the biomass gasifier based on the monitoring equipment's analysis of their composition in order to be reacted with the biomass particles made from the char in the biomass gasifier.

16. The method of claim 13, further comprising:
collecting higher alcohols having two or more carbon atoms per molecule formed as byproducts of the methanol synthesis process;
supplying the higher alcohols to the gasoline blending unit as a gasoline additive to the gasoline produced from a MTG reactor to boost an octane rating of the blended gasoline from the gasoline blending unit.

17. The method of claim 12, further comprising:
producing and collecting 1) condensable materials with significant fuel blending value, 2) char, and 3) non-condensable gases including C1-4 olefins in the torrefaction unit in the first zone;
feeding the char from the torrefaction unit to a particle size reduction unit, in which the char is turned into biomass particles and then pneumatically fed into the biomass gasifier, where a control system for the torrefaction unit thermally decomposes the biomass until the char contains preferably 60-70% of an original mass of the biomass and preferably 80-85% of carbon of an original amount of the biomass fed into the torrefaction unit, where the torrefaction unit has several discrete heating stages set at different operating temperatures and rates of heat transfer within the unit matched to optimize a composition of the non-condensable gases and condensable volatile material produced from the biomass in that stage of the torrefaction unit.

18. The method of claim 12, further comprising
heating the biomass in the torrefaction unit in two or more discrete stages to produce char to be fed to a particle size reduction unit inline with the torrefaction unit in the first zone, and the particle size reduction unit is configured to feed biomass particles generated from the char into an inline feeding system for the biomass gasifier in the second zone, where the torrefaction unit heats the biomass to make the residual char to achieve a desired moisture content, and then the particle size reduction unit generates biomass particles from the char of preferably an average particle size between 10 um to 50 um and in general 0.1 um to 1000 um, and then the biomass particles of the average particle size are fed by the inline feeding system into the biomass gasifier and due to the average particular size of the biomass particles and operating temperature of the reactor of greater than 1000 degrees C. the particles almost immediately flash to ash and gaseous components improving a yield of syngas components generated per amount of biomass supplied and minimizing an amount of residual tar generated in a biomass gasification reaction conducted within the biomass gasifier.

19. The method of claim 17, further comprising:
routing the condensable materials including C5+ hydrocarbons to the gasoline blending unit to increase an octane rating of a blended gasoline product.

20. The method of claim 15, further comprising:
producing and collecting 1) condensable materials with significant fuel blending value, 2) char, and 3) non-condensable gases including C1-4 olefins in the torrefaction unit in the first zone; and
routing 1) the condensable materials with significant fuel blending value to the gasoline blending unit, 2) the char as a feedstock to the biomass gasifier, and 3) the non-condensable gases including C1-4 olefins to a catalytic reactor in parallel with biomass gasifier in order to create the portion of the syngas component to be fed to the methanol synthesis reactor, where the condensable material including the C5+ hydrocarbons are blended with gasoline generated from the syngas gas components produced from the thermal decomposition of the biomass in the first two zones, where the condensable materials includes the C5+ hydrocarbons and H2O the H2O is separated out prior blending the condensable materials includes the C5+ hydrocarbons with the gasoline.
